(19) United States
(12) Patent Application Publication
(10) Pub. No.: US 2019/0159957 A1
(43) Pub. Date: May 30, 2019

(54) Massager For Shoulder And Neck

(71) Applicant: Dongguan Osky Fitness Equipment Tech. Co.,Ltd., Dongguan (CN)

(72) Inventor: Qingyi Zeng, Dongguan (CN)

(21) Appl. No.: 16/147,590

(22) Filed: Sep. 29, 2018

(30) Foreign Application Priority Data
Nov. 28, 2017 (CN) 201711221136.5

(51) Int. Cl. A61H 7/00

(52) U.S. Cl. CPC A61H 7/007; A61H 7/004; A61H 2201/1609; A61H 2205/062; A61H 2201/1215; A61H 2205/04

(57) ABSTRACT

The present invention discloses a massager for shoulder and neck which comprises a driving mechanism, a neck massaging mechanism and a shoulder massaging mechanism; wherein the driving mechanism comprises a power assembly and a transmission assembly, the transmission shaft comprises an upper transmission shaft and a lower transmission shaft; the neck massage mechanism comprises a neck kneading massage assembly and a first eccentric block, the first eccentric block is sleeved on the upper transmission shaft, and the neck kneading massage assembly is arranged on the first linked block; the shoulder massaging mechanism comprises a shoulder massage assembly and a second linked block. The massager for shoulder and neck provided by the invention relieves the pain of the muscles of the shoulder and the neck, promotes the blood circulation of the shoulder part and the neck part, and has an obvious effect to keep a healthy body.

### FIELD OF THE INVENTION

The present disclosure relates to massage field, particularly relates to a massager for shoulder and neck.

### BACKGROUND OF THE INVENTION

Along with the rapid development of the society and human civilization, the work and life rhythm of people is accelerated continuously, and all levels of the society are busy for better life, thus less time for physical exercise, and then the body health index of people is getting worse. It is particularly serious situation for people such as office workers sitting in front of the computer, drivers sitting in a cab for a long time and the like. Due to the fact that it takes a long time to work on a desk or a computer, muscles of the neck, the shoulder and the waist are seriously damaged, the blood circulation is blocked, and periarthritis of shoulder, spinal cervical bone hyperplasia, lumbar disc herniation, etc. are induced.

An auxiliary treatment instrument, namely a shoulder and neck massaging instrument, aiming to solve the above health problems appears on the market. The shoulder neck massaging instrument can be used for massaging and relaxing muscles of the shoulder and neck in a short time, and the pain symptom can be effectively relieved by consistently using the massaging instrument. The existing massaging instrument used for massaging shoulder and neck comprises a shoulder and neck massager, shoulder and neck massaging bags, shoulder and neck massaging shavers and the like.

For example, the Chinese patent application 201510183127.6 discloses a shoulder and neck massager which comprises a massaging mechanism, a shoulder frame and a supporting plate, wherein the shoulder frame is composed of a cross rod and a support, the massaging mechanism is installed on the cross rod, the support comprises a left support and a right support, the upper end of the left support and the upper end of the right support are connected with the two ends of the cross rod respectively, and supporting plates are respectively pivoted to the lower end of the left support and the lower end of the right support.

The Chinese patent 201120491174.4 discloses a shoulder neck massager which comprises a left massaging belt and a right massaging belt, the left massage belt and the right massaging belt are symmetrical and connected into a whole. A plurality of groups of massaging blocks are respectively and symmetrically arranged on the left massaging belt and the right massaging belt, a plurality of first connecting devices with buckling holes are respectively arranged at the two outer sides of the lower end of the left massaging belt and the lower end of the right massaging belt, a plurality of sets of first connecting devices with buckling holes and second connecting devices with lock catches are respectively and symmetrically arranged on the two inner sides of the lower end of the left massaging belt and the lower end of the right massaging belt, the two sides of the public end of the left massaging belt and the right massaging belt are respectively provided with a regulating belt, and the adjusting belt is provided with a third connecting device which is provided with a lock catch for adjusting the self-locking of the adjusting belt.

The defects in the prior art are that the movement mode is single, and most of the massaging modes are 360-degree rotation. The massager of the prior art has the disadvantages of mono massaging part of human body and small massaging range. The above problems cause massage fatigue to the consumers and make the massager of the prior art impossible to meet the needs of people.

### SUMMARY OF THE INVENTION

Aiming at the defects in the prior art, the invention aims to provide a massager for shoulder and neck by which the pain of the muscles of the shoulder and the neck can be relieved, the blood circulation of the shoulder and the neck is promoted, and the effect of keeping a health body is obvious.

To achieve above objects, the present invention discloses a massager for shoulder and neck which comprises a driving mechanism, a neck massaging mechanism and a shoulder massaging mechanism; wherein the driving mechanism comprises a power assembly and a transmission assembly, the power assembly is adapted to drive the transmission assembly, the transmission assembly is provided with a transmission shaft, and the transmission shaft comprises an upper transmission shaft and a lower transmission shaft; the neck massaging mechanism comprises a neck kneading massage assembly and a first linked block, the first linked block is sleeved on the upper transmission shaft, and the neck kneading massage assembly is arranged on the first linked block; and the shoulder massaging mechanism comprises a shoulder massage assembly and a second linked block, the second linked block is sleeved on the lower transmission shaft, and the shoulder massage assembly is arranged on the second linked block.

Comparing with the prior art, the massager for shoulder and neck disclosed by the present invention achieves the effect of enabling people to feel more comfortable by driving the neck massaging mechanism and the shoulder massaging mechanism with the same power assembly.

According to another embodiment of the present invention, longitudinal thickness of the first linked block and/or the second linked varies.

According to another embodiment of the present invention, the first linked block and the second linked block both have eccentric structure, the first linked block is the first eccentric block, the second linked block is the second eccentric block.

According to another embodiment of the present invention, the transmission assembly comprises a worm gear and a worm, the worm is arranged on an output shaft of the power assembly, the worm gear is engaged with the worm, and the worm gear is sleeved on the transmission shaft.

According to another embodiment of the present invention, the driving mechanism further comprises a connecting device, the connecting device comprises a gear box, and the gear box comprises an upper gear box which is sleeved on the upper transmission shaft and a lower gear box which is sleeved on the lower transmission shaft.

According to another embodiment of the present invention, the connecting device further comprises a first orientation frame fixed on the upper gear box, configured to limit motion range of the neck kneading massage assembly

According to another embodiment of the present invention, the first orientation frame comprises a first chassis and a first bracket disposed on the first chassis, the first bracket forms a first cavity;

the first eccentric block is engaged with the upper drive shaft, the first eccentric block is driven to rotate synchronously with the upper drive shaft;

the neck kneading massage assembly comprises a first base, the first base is slidingly sleeved on the first eccentric block, location and angle of the first base is changed when the first eccentric block rotates;

side wall of the first base stretches out a first plug, the first plug is inserted into the first cavity, and outer wall of the first plug and inner wall of the first cavity form a moving space to limit moving distance and tilting angle of the neck kneading massage assembly.

According to another embodiment of the present invention, the connecting device further comprises a second orientation frame fixed on the lower gear box, configured to limit the motion range of the shoulder massage assembly.

According to another embodiment of the present invention, the second orientation frame comprises a second chassis and a second bracket disposed on the second chassis, the second bracket forms a second cavity;

the second eccentric block is engaged with the lower drive shaft, the second eccentric block is driven to rotate synchronously with the lower drive shaft;

the shoulder massage assembly comprises a second base, the second base is slidingly sleeved on the second eccentric block; location and angle of the second base is changed when the second eccentric block rotates;

side wall of the second base stretches out a second plug; the second plug is inserted into the second cavity, outer wall of the second plug and inner wall of the second cavity form a moving space to limit moving distance and tilting angle of the shoulder massage assembly.

According to another embodiment of the present invention, the neck kneading massage assembly further comprises a first massage wheel and a second massage wheel; the first massage wheel and the second massage wheel are staggered and distributed along natural contours of the human body neck.

According to another embodiment of the present invention, the shoulder massage assembly further comprises a second connecting arm and a round massage head, the second base is fixedly mounted on the second eccentric block, and the second base is connected with the round massage head through the second connecting arm.

According to another embodiment of the present invention, the second orientation frame comprises a second chassis and a second bracket disposed on the second chassis, the second bracket forms a second cavity;

the second eccentric block is engaged with the lower drive shaft, the second eccentric block is driven to rotate synchronously with the lower drive shaft;

the shoulder massage assembly comprises a second base, the second base is slidingly sleeved on the second eccentric block; location and angle of the second base is changed when the second eccentric block rotates;

side wall of the second base stretches out a second plug; the second plug is inserted into the second cavity, outer wall of the second plug and inner wall of the second cavity form a moving space to limit moving distance and tilting angle of the shoulder massage assembly.

According to another embodiment of the present invention, the neck kneading massage assembly further comprises a first massage wheel and a second massage wheel; the first massage wheel and the second massage wheel are staggered and distributed along natural contours of the human body neck.

According to another embodiment of the present invention, the shoulder massage assembly further comprises a second connecting arm and a round massage head, the second base is fixedly mounted on the second eccentric block, and the second base is connected with the round massage head through the second connecting arm.

According to another embodiment of the present invention, the massager for shoulder and neck further comprises a shell; side wall of the shell is provided with a protruding portion forming a receiving cavity;

the shoulder massage assembly comprises a second base, a second connecting arm and a round massage head, the second base is fixedly mounted on the second eccentric block, the second base is connected with the round massage head through the second connecting arm; side wall of the second base of the shoulder massage assembly extends out a second plug;

the second base is slidingly sleeved on the second eccentric block, location and angle of the second base is changed when the second eccentric block rotates;

the second plug is inserted into the receiving cavity, outer wall of the second plug and inner wall of the receiving cavity form a moving space to limit moving distance and tilting angle of the shoulder massage assembly.

According to another embodiment of the present invention, the first orientation frame is provided with ribs on left and right sides of the first bracket, and the ribs have triangular shape.

According to another embodiment of the present invention, the second orientation frame is provided with ribs on left and right sides of the second bracket, and the ribs have triangular shape.

According to another embodiment of the present invention, the power assembly is provided with two output shafts Ill which are oppositely arranged, the transmission assembly and the output shaft are equal in number and arranged in one-to-one correspondence.

According to another embodiment of the present invention, the transmission shaft and the transmission assembly are equal in number and arranged in one-to-one correspondence.

According to another embodiment of the present invention, the neck massaging mechanism and the transmission shaft, are equal in number and arranged in one-to-one correspondence; the shoulder massaging mechanism and the transmission shaft are equal in number and arranged in one-to-one correspondence.

According to another embodiment of the present invention, the power assembly is a motor.

The technical solutions of the embodiments according to the present invention are clearly and fully described as below with reference to the accompanying drawings in the embodiments of the present invention. Apparently, the embodiments to be described are merely a part rather than all of the embodiments of the present invention. All other embodiments obtained by persons with ordinary skills in the art based on the embodiments of the present invention without creative efforts shall fall within the protection scope of the present invention.

### BRIEF DESCRIPTION OF THE DRAWINGS

FIG. 1 is a exploded diagram of a massager for shoulder and neck according to embodiment 1;

FIG. 2 is a schematic structural diagram of a driving mechanism of the massager for shoulder and neck according to embodiment 1;

FIG. 3 is a schematic structural diagram of a massager for shoulder and neck according to embodiment 1;

FIG. 4 is another schematic structural diagram of a massager for shoulder and neck according to embodiment 1;

FIG. 5 is a schematic structural diagram of a first orientation frame and a neck kneading massage assembly of the massager for shoulder and neck according to embodiment 1;

FIG. 6 is a schematic structural diagram of a second orientation frame and a shoulder massage assembly of the massager for shoulder and neck according to embodiment 1;

FIG. 7 is a schematic structural diagram of a massager for shoulder and neck according to embodiment 2;

FIG. 8 is another schematic structural diagram of a massager for shoulder and neck according to embodiment 2; and

FIG. 9 is a schematic structural diagram of a shell of the massager for shoulder and neck according to embodiment 1.

### DETAILED DESCRIPTION OF ILLUSTRATED EMBODIMENTS

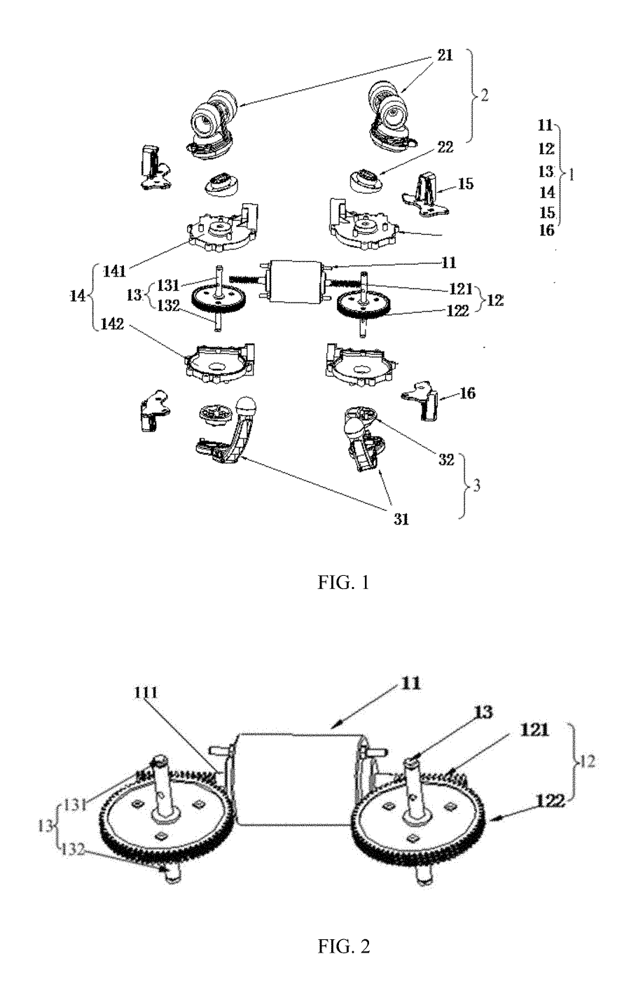

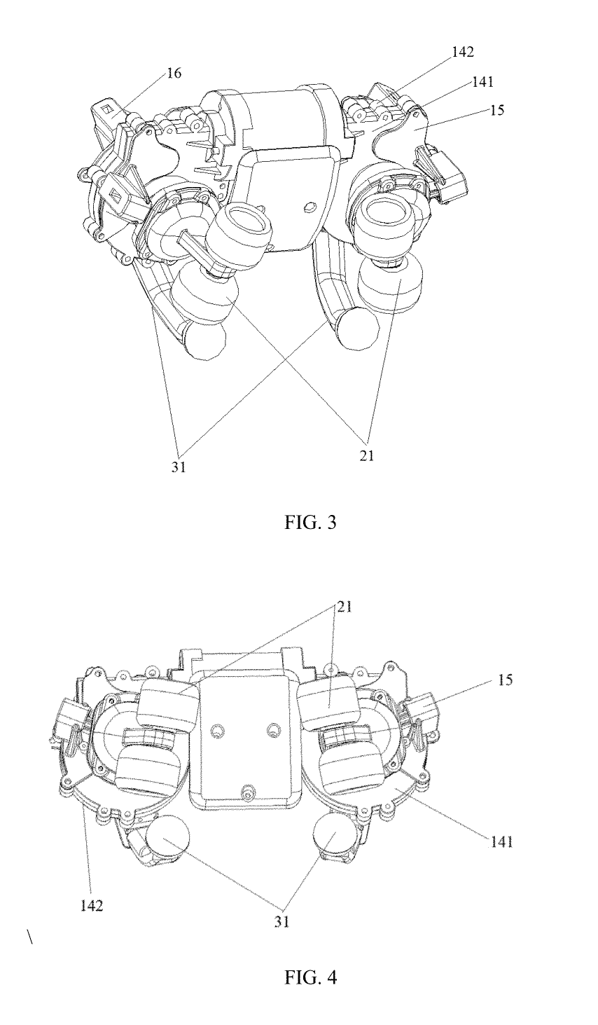

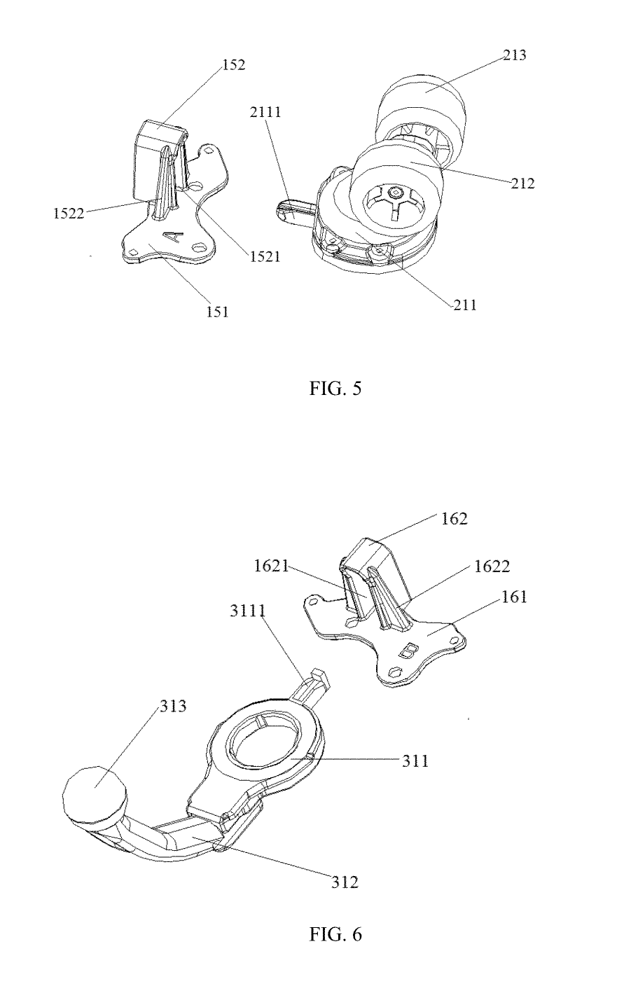

Referring to FIG. 1 to FIG. 6, the massager for shoulder and neck comprises a driving mechanism 1, a neck massaging mechanism 2 and a shoulder massaging mechanism 3.

The driving mechanism 1 comprises a power assembly 11, a transmission assembly 12, a transmission shaft 13, a gear box 14, a first orientation frame 15 and a second orientation frame 16. The power assembly 11 is a motor 11 which is provided with two output shafts 111; the transmission assembly 12 comprises a worm gear 122 and a worm 121, the worm 121 is arranged on an output shaft of the power assembly 11, the worm gear 122 is engaged with the worm 121, and the worm gear 122 is sleeved on the transmission shaft 13. The number of the transmission shaft 13 is two and the two transmission shafts 13 are respectively arranged on the two output shafts 111; the transmission shaft 13 comprises an upper transmission shaft 131 and a lower transmission shaft 132.

The gear box 14 comprises an upper gear box 141 and a lower gear box 142, the upper gear box 141 is sleeved on the upper transmission shaft 131 and the lower gear box 142 is sleeved on the lower transmission shaft 132. The first orientation frame 15 is fixed on the upper gear box 141 and the second orientation frame 16 is fixed on the lower gear box 142.

The neck massaging mechanism 2 comprises a neck kneading massage assembly 21 and a first eccentric block 22, the first eccentric block 22 is sleeved on the upper transmission shaft 131, and the neck kneading massage assembly 21 is arranged on the first eccentric block 22.

The neck kneading massage assembly 21 comprises a first base 211. The first base 211 is slidingly sleeved on side wall of the first eccentric block 22, and side wall of the first base 211 stretches out a first plug 2111.

The shoulder massaging mechanism 3 comprises a shoulder massage assembly 31 and a second eccentric block 32, the second eccentric block 32 is sleeved on the lower transmission shaft 132, and the shoulder massage assembly 31 is arranged on the second eccentric block 32. The shoulder massage assembly 31 comprises a second base 311. The second base 311 is slidingly sleeved on the side wall of second eccentric block 32, and side wall of the second base 311 stretches out a second plug 3111.

The first eccentric block 22 and the second eccentric block 32 has a longitudinal thickness variation structure (for example, the thickness in the direction along the transmission shaft 13 gradually increases from one side to the other) and eccentric structure (that is, position of the first eccentric block 22/the second eccentric block 32 connected with the transmission shaft 13 is not in the center of the first eccentric block 22/the second eccentric block 32).

The first orientation frame 15 comprises a first chassis 151 and a first bracket 152 disposed on the first chassis 151, the first bracket 152 forming a first cavity 1521. The neck kneading massage assembly 21 comprises a first base 211, and side wall of the first base 211 stretches out a first plug 2111; the first eccentric block 22 is engaged with the upper drive shaft 131, the first eccentric block 22 is driven to rotate synchronously with the upper drive shaft 131; and the first base 211 is slidingly sleeved on outer wall of the first eccentric block 22; location and angle of the first base 211 is changed when the first eccentric block 22 rotates, due to that the first eccentric block 22 has a longitudinal thickness variation structure and eccentric structure; the first plug 2111 is inserted into the first cavity 1521, and outer wall of the first plug 2111 and inner wall of the first cavity 1521 form a moving space to limit moving distance and tilting angle of the neck kneading massage assembly 21.

Similarly, the second orientation frame 16 comprises a second chassis 161 and a second bracket 162 disposed on the second chassis 161, the second bracket 162 forms a second cavity 1621; the shoulder massage assembly 31 comprises a second base 311, and side wall of the second base 311 stretches out a second plug 3111; the second eccentric block 32 is engaged with the lower drive shaft 132, the second eccentric block 32 is driven to rotate synchronously with the lower drive shaft 132; and the second base 311 is slidingly sleeved on outer wall of the second eccentric block 32; location and angle of the second base 311 is changed when the second eccentric block 32 rotates, due to that the second eccentric block 32 has a longitudinal thickness variation structure and eccentric structure; the second plug 3111 is inserted into the second cavity 1621, and outer wall of the second plug 3111 and inner wall of the second cavity 1621 form a moving space to limit moving distance and tilting angle of the shoulder massage assembly 31.

In the embodiment of the present invention, the transmission assembly 12 and the output shaft 111 are equal in number and arranged in one-to-one correspondence. The transmission shaft 13 and the transmission assembly 12 are equal in number and arranged in one-to-one correspondence. The neck massaging mechanism 2 and the transmission shaft 13 are equal in number and arranged in one-to-one correspondence; the shoulder massaging mechanism 3 and the transmission shaft 13 are equal in number and arranged in one-to-one correspondence.

Due to the motor 11 provided with two output shafts 111, the number of the transmission assemblies 12 corresponds to two and the two transmission assemblies are respectively arranged on the two output shafts 111; the number of the transmission shafts 13 is two, which are respectively arranged on the two transmission assemblies 12; both of the number of the neck massaging mechanisms 2 and the number of the shoulder massaging mechanisms 3 are two, which are respectively arranged on the two transmission shafts 13.

The operation process of the massager for shoulder and neck provided by the present embodiment comprises the following explanation:

1. Due to that the motor is fixed between left and right gear boxes, the motor provides power for the left worm gear and right worm gear in parallel through the transmission between the worm gear and the worm, thereby driving the two worm gears to rotate relative to each other synchronously.

2. The worm gear 122 is sleeved on the transmission shaft 13, the first eccentric block 22 is sleeved on the upper transmission shaft 131, and the first base 211 of the neck kneading massage assembly 21 sleeved is slidingly on outer wall of the first eccentric block 22. So when starting the motor 11, the transmission shaft 13 rotates and drives the first eccentric block 22 to rotate. Since the first base 211 is slidingly arranged with the outer wall of the first eccentric block, the first base 211 does not rotate with the first eccentric block 22. However, since the first eccentric block has a structure that the longitudinal thickness changes, when the first eccentric block rotates, inclination angle of the first base 211 sleeved on the first eccentric block 22 changes. Moreover, since the first eccentric block 22 has an eccentric structure, the first base block 211 sleeved on the outer wall of the first eccentric block 221 would be pushed to move by the outer wall of the first eccentric block 22 during rotating. Then, since the first plug 2111 is inserted into the first cavity 1521, the first base 211 can only move within a moving space formed by outer wall of the first plug 2111 and the inner wall of the first cavity 1521. Thus, motion of the neck kneading massage assembly 21 can be guided, and the moving distance and inclination angle of the neck kneading massage assembly 21 can be limited. As the left and right neck kneading massage assembles 21 rotate relative to each other, the manual pressing and loosening massage techniques can be simulated, leading to a squeezing and kneading actions on human neck, thereby bringing a good experience to users. Due to change of position and angle of the neck kneading massage assembly 21, inward and outward kneading and 3D kneading can be achieved.

In addition, the neck kneading massage assemblies 21 also comprises a first massage wheel 212 and a second massage wheel 213.

The first massage wheel 212 and the second massage wheel 213 are staggered along the natural contours of human body (i.e., axis of the first massage wheel 212 and axis of the second massage wheel 213 are in an unaligned state), the first massage wheel 212 and the second massage wheel 213 can fit the skin of the neck with different curvatures, and the massager massages neck muscles in a larger area during using. Preferably, the first massage wheel 212 and the second massage wheel 213 are connected through a connecting rod, and the first base 211 is connected to the connecting rod through a first connecting arm.

Preferably, the first orientation frame 15 is provided with ribs 1522 on left and right sides of the second bracket 152, and the ribs 1522 have triangular shape.

3. The worm gear 122 is sleeved on the transmission shaft 13, the first eccentric block 22 is sleeved on the upper transmission shaft 131, and the first base 211 of the neck kneading massage assembly 21 sleeved is slidingly on the first eccentric block 22. So when starting the motor 11, the transmission shaft 13 rotates and drives the t first eccentric block 22 to rotate. Since the first base 211 is slidingly disposed with the outer wall of the first eccentric block, the first base 211 does not rotate with the first eccentric block 22. However, since the first eccentric block has a structure in which the longitudinal thickness changes, when the first eccentric block rotates, inclination angle of the first base 211 sleeved on the first eccentric block 22 changes. Moreover, since the first eccentric block 22 has an eccentric structure, the first base block 211 sleeved on the outer wall of the first eccentric block 221 would be pushed to move by the outer wall of the first eccentric block 22 during rotating. Then, since the first plug 2111 is inserted into the first cavity 1521, the first base 211 can only move within a moving space formed by outer wall of the first plug 2111 and the inner wall of the first cavity 1521. Thus, motion of the neck kneading massage assembly 21 can be guided, and the moving distance and the inclination angle of the neck kneading massage assembly 21 can be limited. As the left and right neck kneading massage assembles 21 rotate relative to each other, the manual pressing and loosening massage techniques can be simulated, leading to a squeezing and kneading actions on human shoulder, thereby bringing a good experience to users. Due to change of position and angle of the neck kneading massage assembly 21, inward and outward kneading and 3D kneading can be achieved.

Preferably, the shoulder massage assembly 31 further comprises a second connecting arm 312 and a round massage head 313. The second base 311 is connected with the round massage head 313 through the second connecting arm 313. The massage round head 313 has a spherical structure and can provide a comfortable massage experience for users.

Preferably, the second orientation frame 16 is provided with ribs 1622 on left and right sides of the second bracket 162, and the ribs 1622 have triangular shape.

By performing the present embodiment, the transmission shaft 13 is rotated to drive left and right first eccentric blocks 22 to rotate relative to each other, thus achieving a comfortable grabbing and releasing massage action for neck muscle of human being. At the same time, left and right second eccentric blocks 32 is rotated relative to each other, thus realizing grabbing towards middle of the shoulder.

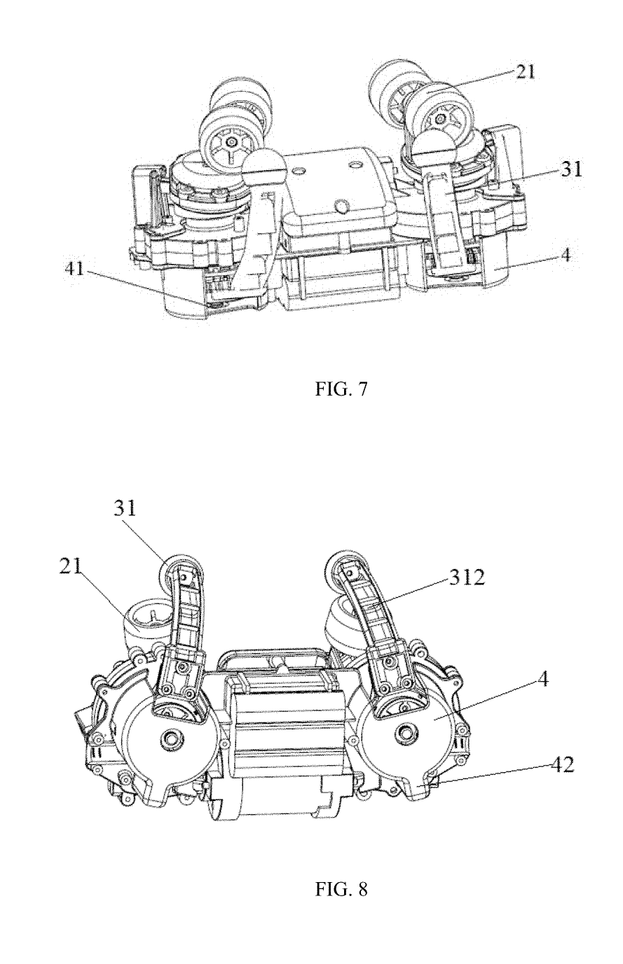

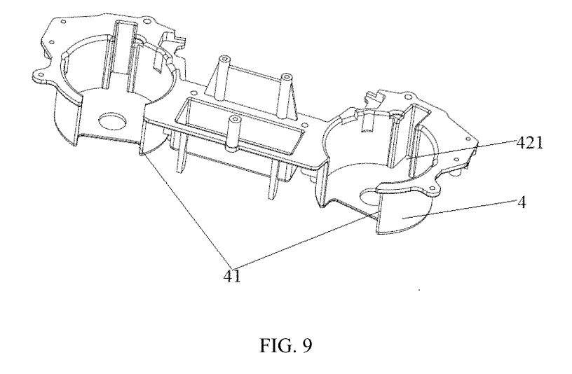

Referring to FIG. 7 to FIG. 9, According to another preferred embodiment, based on embodiment 1, the second eccentric blocks 32 is replaced by a shell 4, which is covering the lower gear box 142 and the second base 311 of the shoulder massage assembly 31, and the second connecting arm 312 of the shoulder massage assembly 31 stretches out of opening 41 of the shell 4; side wall of the shell 4 is provided with a protruding portion 42 forming a receiving cavity 421; side wall of the second base 311 of the shoulder massage assembly 31 extends out a second plug 3111; the second plug 3111 is inserted into the receiving cavity 421, and outer wall of the second plug 3111 and inner wall of the receiving cavity 421 form a certain moving space to limit moving distance and tilting angle of the shoulder massage assembly.

Aiming at pain or discomfort of the shoulder and neck of most people, the massager for shoulder and neck provided according to embodiments in the present disclosure relieves the pain of the muscles of the shoulder and the neck, promotes the blood circulation of the shoulder part and the neck part, and has an obvious effect to keep a healthy body. The shoulder massaging mechanism 3D simulates an shoulder-grabbing action of external human hands, and the neck massaging mechanism 3D extrudes and kneads; the shoulder massaging mechanism and the neck massaging mechanism are driven by a motor to drive two groups of massaging actions to be synchronously carried out, so that people can feel more comfortable.

The foregoing descriptions are merely exemplary embodiments of the present invention, but are not intended to limit the present disclosure.

Any modifications, equivalent substitutions, and improvements made by those skilled in the art within the spirit and principle of the present disclosure shall fall within the protection scope of the present disclosure.

What is claimed is:

1. A massager for shoulder and neck, which is characterized by comprising:
a driving mechanism which comprises a power assembly and a transmission assembly, the power assembly is adapted to drive the transmission assembly, the transmission assembly is provided with a transmission shaft, and the transmission shaft comprises an upper transmission shaft and a lower transmission shaft;
a neck massaging mechanism which comprises a neck kneading massage assembly and a first linked block, the first linked block is sleeved on the upper transmission shaft, and the neck kneading massage assembly is arranged on the first eccentric block; and
a shoulder massaging mechanism which comprises a shoulder massage assembly and a second linked block, the second linked block is sleeved on the lower transmission shaft, and the shoulder massage assembly is arranged on the second eccentric block.

2. The massager for shoulder and neck according to claim 1, longitudinal thickness of the first linked block and/or the second linked varies.

3. The massager for shoulder and neck according to claim 2, wherein the first linked block and the second linked block both have eccentric structure, the first linked block is the first eccentric block, the second linked block is the second eccentric block.

4. The massager for shoulder and neck according to claim 3, wherein the transmission assembly comprises a worm gear and a worm, the worm is arranged on an output shaft of the power assembly, the worm gear is engaged with the worm, and the worm gear is sleeved on the transmission shaft.

5. The massager for shoulder and neck according to claim 4, wherein the driving mechanism further comprises a connecting device, the connecting device comprises a gear box, and the gear box comprises an upper gear box which is sleeved on the upper transmission shaft and a lower gear box which is sleeved on the lower transmission shaft.

6. The massager for shoulder and neck according to claim 5, wherein the connecting device further comprises a first orientation frame fixed on the upper gear box, configured to limit motion range of the neck kneading massage assembly.

7. The massager for shoulder and neck according to claim 6, wherein the first orientation frame comprises a first chassis and a first bracket disposed on the first chassis, the first bracket forms a first cavity;
the first eccentric block is engaged with the upper drive shaft, the first eccentric block is driven to rotate synchronously with the upper drive shaft;
the neck kneading massage assembly comprises a first base, the first base is slidingly sleeved on outer wall of the first eccentric block, location and angle of the first base is changed when the first eccentric block rotates; and
side wall of the first base stretches out a first plug, the first plug is inserted into the first cavity, and outer wall of the first plug and inner wall of the first cavity form a moving space to limit moving distance and tilting angle of the neck kneading massage assembly.

8. The massager for shoulder and neck according to claim 7, wherein the connecting device further comprises a second orientation frame fixed on the lower gear box, configured to limit the motion range of the shoulder massage assembly.

9. The massager for shoulder and neck according to claim 8, wherein the second orientation frame comprises a second chassis and a second bracket disposed on the second chassis, the second bracket forms a second cavity;
the second eccentric block is engaged with the lower drive shaft, the second eccentric block is driven to rotate synchronously with the lower drive shaft;
the shoulder massage assembly comprises a second base, the second base is slidingly sleeved on outer wall of the second eccentric block; location and angle of the second base is changed when the second eccentric block rotates; and
side wall of the second base stretches out a second plug; the second plug is inserted into the second cavity, outer wall of the second plug and inner wall of the second cavity form a moving space to limit moving distance and tilting angle of the shoulder massage assembly.

10. The massager for shoulder and neck according to claim 9, wherein the neck kneading massage assembly further comprises a first massage wheel and a second massage wheel; the first massage wheel and the second massage wheel are staggered and distributed along natural contours of the human body neck.

11. The massager for shoulder and neck according to claim 9, wherein the shoulder massage assembly further comprises a second connecting arm and a round massage head, the second base is fixedly mounted on the second eccentric block, and the second base is connected with the round massage head through the second connecting arm.

12. The massager for shoulder and neck according to claim 7, wherein the massager for shoulder and neck further comprises a shell; side wall of the shell is provided with a protruding portion forming a receiving cavity;
the shoulder massage assembly comprises a second base, a second connecting arm and a round massage head, the second base is fixedly mounted on the second eccentric block, the second base is connected with the round massage head through the second connecting arm; side wall of the second base of the shoulder massage assembly extends out a second plug
the second base is slidingly sleeved on the second eccentric block, location and angle of the second base is changed when the second eccentric block rotates; and
the second plug is inserted into the receiving cavity, outer wall of the second plug and inner wall of the receiving cavity form a moving space to limit moving distance and tilting angle of the shoulder massage assembly.

13. The massager for shoulder and neck according to claim 7, wherein the first orientation frame is provided with ribs on left and right sides of the first bracket, and the ribs have triangular shape.

14. The massager for shoulder and neck according to claim 9, wherein the second orientation frame is provided with ribs on left and right sides of the second bracket, and the ribs have triangular shape.

15. The massager for shoulder and neck according to claim 1, wherein the power assembly is provided with two output shafts which are oppositely arranged, the transmission assembly and the output shaft are equal in number and arranged in one-to-one correspondence.

16. The massager for shoulder and neck according to claim 15, wherein the transmission shaft and the transmission assembly are equal in number and arranged in one-to-one correspondence.

17. The massager for shoulder and neck according to claim 16, wherein the neck massaging mechanism and the transmission shaft are equal in number and arranged in one-to-one correspondence; the shoulder massaging mechanism and the transmission shaft are equal in number and arranged in one-to-one correspondence.

18. The massager for shoulder and neck according to claim 17, wherein the power assembly is a motor.
